(19) United States
(12) Patent Application Publication
(10) Pub. No.: US 2020/0029555 A1
(43) Pub. Date: Jan. 30, 2020

(54) BIODEGRADABLE HYDROGEL TO DELIVER AQUEOUS BAIT TO CONTROL PEST ANTS

(71) Applicants: Dong-Hwan Choe, Riverside, CA (US); Jia-Wei Tay, Riverside, CA (US); Ashok Mulchandani, Riverside, CA (US); Mark Hoddle, Riverside, CA (US); Michael Rust, Riverside, CA (US)

(72) Inventors: Dong-Hwan Choe, Riverside, CA (US); Jia-Wei Tay, Riverside, CA (US); Ashok Mulchandani, Riverside, CA (US); Mark Hoddle, Riverside, CA (US); Michael Rust, Riverside, CA (US)

(21) Appl. No.: 16/337,166

(22) PCT Filed: Sep. 27, 2017
(86) PCT No.: PCT/US2017/053761

§ 371 Date: Mar. 27, 2019

Related U.S. Application Data
(60) Provisional application No. 62/400,161, filed on Sep. 27, 2016.

(51) Int. Cl. A01N 25/04; A01N 43/88; A01N 49/00

(52) U.S. Cl. CPC A01N 25/04; A01N 49/00; A01N 43/88

(57) ABSTRACT

A biodegradable hydrogel is disclosed for delivering aqueous bait to control pest ants. The biodegradable hydrogel includes a natural polymer of alginate cross-linked with calcium ions. A method of forming a biodegradable hydrogel is disclosed for delivering aqueous bait to control pest ants, the method includes ionotropically cross-linking sodium alginate with calcium ions.

### CROSS-REFERENCES TO RELATED APPLICATIONS

This application claims priority to U.S. Patent Application Ser. No. 62/400,161 filed on Sep. 27, 2017, the entire content of which is incorporated herein by reference.

### TECHNICAL FIELD

The present invention relates to pest ant management in urban, agricultural, and natural settings, and more particularly, development of biodegradable hydrogel matrices to deliver the liquid baits targeting invasive pest ant populations.

### BACKGROUND

The Argentine ant, Linepithema humile (Mayr) is a widespread invasive species worldwide (Wild, 2004; Wetterer et al., 2009). It is one of the most damaging pest ant species, in urban, agricultural, and natural environments. In common with other tramp ant species such as Monomorium pharaonis (L.) (Passera, 1994; Tay and Lee, 2015), L. humile has a high reproductive rate, polygynous colony structure, exhibits unicoloniality, and can propagate via budding. Furthermore, Argentine ant colonies can continue reproduction even when a single queen and a few workers are available. This aspect of Argentine ant biology might explain why this species is particularly difficult to eliminate once the populations establish in new locations.

Argentine ants often establish extensive area-wide infestations in urban settings, making them a serious nuisance pest. For example, in urban residential settings of California, Argentine ant is one of the most common pest ant species treated by pest management professionals. In agricultural settings, Argentine ants readily establish trophobiotic relationship with honeydew-producing hemipteran pests. The hemipteran honeydew serves as an important nutrient source that supports the large population of Argentine ants, and the presence of tending Argentine ants protects the hemipteran pests from their natural enemies such as parasitoids. Thus, it is critical to disrupt ant-hemipteran interactions by providing effective ant management programs in order to avoid them interfering with biological control programs in agricultural environments.

Due to their several practical advantages such as easy application and relatively quick suppression of pest ant populations, insecticide sprays are one of the common options to control Argentine ant in urban and agricultural settings. In urban residential settings, pest management professionals typically utilize sprays containing active ingredients such as phenylpyrazole and pyrethroids to control Argentine ants. In citrus orchards and grape vineyards of California, an organophosphate spray is one of the typical options to restrict pest ants' access to honeydew and honeydew-producing hemipterans. However, there have been concerns associated with the commonly used spray insecticides, such as soil and water contaminations, and potential health risks to workers and non-target organisms. In addition, certain types of spray products (for example, emulsifiable concentrates (EC)) are known to significantly contribute to volatile organic compounds (VOC) emissions, potentially impacting the air quality.

Hence, liquid baits have been investigated as one of the alternatives to these insecticide sprays to control ants. Sugary liquid bait formulated with slow-acting toxicant at the right concentration has been demonstrated as an effective control method for large Argentine ant colonies. In theory, sugary liquid would make an ideal bait because of its resemblance to the ants' natural liquid food source, honeydew. However, several factors prevent the liquid baiting from being widely adopted for practical ant management. For example, liquid baits cannot be broadcasted, requiring bait stations to contain and dispense the bait. Bait stations are costly and require frequent maintenance (for example, inspection, cleaning, refilling, etc.). Installation and maintenance of many bait stations over a large area are often necessary to achieve an acceptable level of control. In addition, there are challenges originating from common design factors of current bait stations, for example, a bait reservoir and dispenser. The evaporation of water from the liquid bait in the dispenser can increase concentrations of sugar and active ingredient in the bait, eventually leaving the bait in the dispenser less palatable to foraging ants. In addition, aqueous sugar baits contained in the bait reservoir tend to ferment under warm environmental conditions, consequently compromising the continued foraging and acceptance by target ant species.

To overcome these limitations of conventional liquid baiting, a hydrogel matrix has been studied as a method to deliver the aqueous liquid bait without bait stations. To date, a synthetic hydrogel composed of polyacrylamide has been tested to deliver sucrose liquid baits targeting Argentine ants. The use of hydrogel matrices makes it possible to apply the liquid baits directly on the ground where ants are typically foraging and nesting. The highly absorbent hydrogel matrices keep the liquid bait palatable for an extended period of time by retaining water, essentially acting as a control-release vehicle.

However, polyacrylamide hydrogels are not readily biodegradable, so they tend to accumulate on the soil surface after being applied. In addition, exposure to light and heat can decompose polyacrylamide to its monomer, acrylamide, a chemical that is listed as toxic by World Health Organization (World Health Organization, 1985) and the state of California. Some research even indicated that acrylamide could be a peripheral nerve toxin and a potential carcinogen to human.

### SUMMARY

In consideration of the above issues, it would be desirable to have a novel baiting technology using the biodegradable hydrogel, which does not require the conventional baiting stations, providing less expensive and less labor-intensive option for ant baiting. In accordance with an exemplary embodiment, the novel baiting technology using the biodegradable hydrogel does not produce any potentially harmful degradation products from the hydrogel compounds unlike other synthetic hydrogel options such as polyacrylamide. In addition, the biodegradable hydrogel will be readily decomposed once it is applied in the field. Compared to other conventional sprays, the amount of insecticide applied in the field in this novel baiting technique will be much lower. The addition of the species-specific pheromone in the biodegradable hydrogel bait will increase the efficacy of the baiting.

In accordance with an exemplary embodiment, biodegradable hydrogel baits have been developed and evaluated that could revolutionize ant-baiting practices in many different environmental settings. Hydrogel baits encapsulate sucrose liquid laced with tiny amounts of pesticide, allowing ants to feed from the hydrogel surface. This method of novel baiting will not require conventional bait stations, which are typically expensive and tough to service/maintain. The addition of a species-specific pheromone in the hydrogel will also increase attractiveness of the biodegradable hydrogel bait to a target ant species.

A biodegradable hydrogel is disclosed for delivering aqueous bait to control pest ants, the biodegradable hydrogel comprising: a natural polymer of alginate cross-linked with calcium ions.

A method of forming a biodegradable hydrogel for delivering aqueous bait to control pest ants, the method comprising: ionotropically cross-linking sodium alginate with calcium ions.

### BRIEF DESCRIPTION OF THE DRAWINGS

FIG. 1 is a chart showing percentages of water loss (mean±SE) of hydrogel matrices under various % RH and substrate moisture conditions, and wherein for each time period, symbols labeled with the same letters are not significantly different at P=0.05 (Tukey's HSD).

FIG. 2 is an illustration of a choice feeding arena with hydrogel matrices that lost 0, 25%, 50%, 75% of water at 5 minutes post introduction into test arenas.

FIG. 3: is a chart showing number (mean±SE) of ants feeding on hydrogel beads over time, wherein the legend shows different levels of water loss for the hydrogel matrices, and for each time period, symbols labeled with the same letters are not significantly different at P=0.05 (square-root transformed data, Tukey's HSD test).

FIGS. 4A-4C are SEM images of surface morphology of Ca-Alg hydrogel bead, wherein FIG. 4A is 80× magnification (wet hydrogel bead, Hitachi™-1000 tabletop SEM), FIG. 4B is 250× magnification (FEI Nova NanoSEM 450), and FIG. 4C is 1000× magnification (FEI Nova NanoSEM 450).

FIG. 5 is Table 1, which illustrates 27 different combinations of hydrogel matrix preparation conditions.

FIG. 6 is Table 2, which is an analysis of variance results for hydrogel percentage weight under different combinations of preparation conditions.

FIG. 7 is Table 3, which illustrates percentage of diameter increase and weight gain of the hydrogel beads conditioned in various solutions.

FIG. 8 is Table 4, which illustrates effects of different concentrations of thiamethoxam hydrogel baits on the percentage reduction of laboratory colonies of worker ants.

FIG. 9 is Table 5, which illustrates effect of different concentrations of thiamethoxam hydrogel baits on the percentage reduction of laboratory colonies of queen ants.

FIG. 10 is Table 6, which illustrates effect of different concentrations of thiamethoxam hydrogel baits on the percentage reduction of laboratory colonies of brood ants.

### DETAILED DESCRIPTION

The use of natural hydrogel matrices that are readily biodegradable would eliminate some of aforementioned limitations associated with the synthetic polymer. In the current study, a natural polymer made of alginate, a polysaccharide extracted from seaweeds or algae, was investigated for its potential use as an alternative hydrogel material to deliver aqueous liquid baits. The alginate hydrogels have been used to deliver various compounds such as fertilizers, contact pesticides, and pharmaceuticals. The alginate hydrogel with necessary absorptive property was engineered by optimizing the ionotropical cross-linking process of sodium alginate with calcium ions. Using thiamethoxam as the insecticidal active ingredient, laboratory studies were conducted to determine the effectiveness of the alginate hydrogel to absorb and deliver the liquid bait for Argentine ant populations.

### Materials and Methods

Experiment 1 was conducted to identify the method to produce alginate hydrogel beads with optimal property. Using the alginate hydrogel beads produced with the methods identified from experiment 1, experiment 2-5 were conducted to determine the potential of the alginate hydrogel bead as a matrix to deliver liquid baits targeting Argentine ants. Experiment 2 was conducted to determine water loss characteristics of alginate hydrogel beads under simulated moisture conditions. Experiment 3 was conducted to assess bait acceptance to foraging Argentine ants as alginate hydrogel baits desiccated. Experiment 4 was conducted to characterize the alginate hydrogel beads when they are conditioned in a sucrose solution containing various concentrations of an insecticidal active ingredient, thiamethoxam. Experiment 5 was conducted to determine if thiamethoxam migrates into the entire alginate hydrogel beads upon conditioning in the sucrose liquid bait. Lastly, experiment 6 and 7 were conducted to determine the efficacy of the alginate hydrogel baits to control Argentine ants under laboratory and field conditions.

### Experiment 1: Engineering Alginate Hydrogel with Optimal Properties

Spherical hydrogel baits with larger diameter are easier to be applied in the field. In addition, the hydrogel matrix that absorbs a maximum amount of liquid bait per weight would allow more efficient delivery of the liquid bait. Thus, firm spherical shape and high absorbency for aqueous sucrose solution (expressed as percentage weight gain when fully swollen in the sucrose solution) were considered as optimal properties for alginate hydrogel. The alginate hydrogel was prepared by ionotropically cross-linking sodium alginate with calcium ions. Total 27 different combinations of following parameters were used for the hydrogel preparation: sodium alginate (Na-Alg) concentration (1, 1.5, and 2%), calcium chloride (CaCl₂) concentration (0.5, 1, and 2%) and crosslinking time (5, 15, and 30 min) (Table 1). To obtain 1, 1.5 or 2% Na-Alg solutions, either 1, 1.5 or 2 g of medium-viscosity Na-Alg (Sigma Aldrich, St. Louis, Mo., USA) was mixed in 100 ml of deionized water, respectively. The mixture was gradually heated to 60° C. while stirring to achieve complete dissolution of Na-Alg, and subsequently cooled down to room temperature. Next, the Na-Alg solution was added into the crosslinker, either 0.5, 1, or 2% CaCl₂ (wt:vol) solution, using a 5-ml syringe (Becton Dickinson Labware, Franklin Lakes, N.J., USA). The Na-Alg solution was dispensed dropwise from the syringe through a 100-mm piece of Tygon tubing (Vincon flexible PVC tubing, 9.5 mm ID, 12.7 mm OD, 1.7 mm wall thickness; Saint-Gobain Performance Plastics, Garden Grove, Calif., USA) with the end covered with a piece of fine fabric screen (30 mm by 30 mm). This modification allowed the accumulation of relatively large amount 0.15 ml) of Na-Alg solution at the end of the tubing before the drop was detached and dropped into the cross-linking solution, maximizing the size of hydrogel beads formed. The crosslinker was continuously stirred with magnetic stirring bar throughout this process. Lastly, the resulting hydrogel beads were filtered out from CaCl₂ solution after 5, 15, or 30 minutes and briefly rinsed with deionized water to remove the cross-linking solution from the surface.

After gently removing the excess moisture with a laboratory tissue (Kimberly-Clark Professional, Roswell, Ga., USA), each hydrogel bead was weighed on an analytical scale (AE 240, Mettler-Toledo, Columbus, Ohio, USA). This weight was recorded as the “initial” weight. Each bead was then submerged in 100 ml of 25% (wt:vol) sucrose solution for 24 h (“conditioning”). Following the 24-hour (24-h) conditioning period, the fully swollen beads were removed from the sucrose solution and weighed after removing excess moisture on the surface with a laboratory tissue. This weight was recorded as the “final” weight. Each treatment was replicated ten times.

Univariate analysis of variance (ANOVA) was used to evaluate the hydrogel percentage weight gain in the different preparation parameters (for example, Na-Alg concentration, crosslinker concentration, and crosslinking time), as well as the full factorial interactive effects of different preparation parameters. Stepwise multiple linear regression analysis was used to determine the predictive power of the variables that could account for a significant proportion of the variance in the regression model of percentage weight gain (SPSS Inc, 2002).

### Experiment 2: Water Loss of Alginate Hydrogel Beads Under Simulated Moisture Conditions

Argentine ants show the highest foraging activity in warm summer months, while preferring locations where irrigation is available. Thus, the alginate hydrogel baits targeting Argentine ants could be exposed to varying moisture conditions. Since the moisture contents in the bait matrix impacts the palatability of the bait for foraging ants, it would be important to understand the water loss dynamics of the alginate hydrogel beads in several realistic moisture conditions. To simulate varying moisture conditions of the ground surface and atmosphere, six different combinations of dry or wet substrate conditions and three different relative humidity (RH) levels were tested. Alginate hydrogel beads conditioned in a 25% sucrose solution were weighed and placed on surface of the wet or dry sand (40 g, play sand, The Quikrete International Inc., Atlanta, Ga.) contained in uncovered petri dishes (100 mm in diameter and 15 mm in height). The wet sand was prepared by adding 0.1 g of water per gram of sand wile stirring, providing 10% (wt:wt) moisture level (Ace Glass, Inc., Vineland, N.J., USA). For the dry sand treatment, the sand was used without added water. The sand dishes with hydrogel beads were placed in desiccators (240 mm in diameter) containing either 500 g of silica gel (0-5% RH), a saturated MgCl₂ salt solution (32% RH), or a saturated NaCl salt solution (75% RH). The desiccators were placed in an incubator at 25.6° C. Temperature and humidity levels inside the desiccators were continuously recorded using HOBO UX100 detectors (Onset Computer Corp., Bourne, Mass., USA). The hydrogel beads were weighed at 2 hours (2 h), 4 hours (4 h), 6 hours (6 h), 8 hours (8 h), and 24 hours (24 h). Sand particles attached to hydrogel surfaces was carefully removed prior to weighing. After 24 h, all of the hydrogel beads were placed in a desiccator maintained at a 0-5% RH level (silica gel). The hydrogel beads were weighed daily until there were identical successive weights, indicating all the water had been lost. Weight difference between the initial hydrogel bead and the completely dehydrated hydrogel bead was considered as total amount of water initially absorbed by the hydrogel bead. The initial total amount of water in the hydrogel bead was used to determine the percent water loss at a given time point. Experiment was replicated ten times. The percentage of water loss was normalized using an arcsine square-root transformation. One-way ANOVA and Tukey's HSD test were used to compare the mean percentages of water loss at each time point (SPSS Inc, 2002).

### Experiment 3: Choice Feeding Study with Partially Dehydrated Hydrogel Matrices

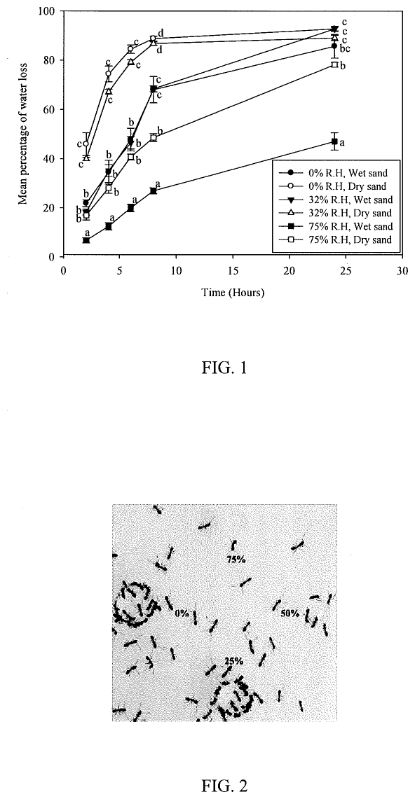

To determine ants' feeding responses for hydrogel beads at various levels of desiccation, ants were given a choice of hydrogel beads at four different levels of desiccation (0, 25%, 50%, and 75% water loss). To prepare the hydrogel beads with 25%, 50%, and 75% water loss, alginate hydrogel beads were first conditioned in 25% sucrose solution for 24 h and subsequently subjected to a constant moisture condition (0-5 RH on wet sand) within a desiccator for 2.5 hours (2.5 h), 6.3 hours (6.3 h) and 14.5 hours (14.5 h), respectively (based on experiment 2, see FIG. 1).

Colonies of L. humile were collected along with their nesting materials from a citrus grove located at the University of California, Riverside, Calif. The ants were extracted from the soil, leaf litter, and debris by spreading these nesting materials thinly within a large wooden box. Moist plaster nests were positioned at the center of the box. As the nesting materials dried up, entire colony of ants moved into the plaster nests, and the colony was subsequently transferred into plastic containers maintained in the laboratory. For the choice feeding study, each colony was prepared in a polyethylene container (330 mm by 190 mm by 100 mm), inner side surface of which were coated with a thin film of Teflon (polytetrafluoroethylene suspension; BioQuip, Rancho Dominguez, Calif.) in order to prevent the ants from escaping. Each colony consisted of 300 workers, two queens and 0.1 g of brood.

Four hydrogel beads with 0, 25%, 50%, and 75% water loss were simultaneously placed on the bottom of the colony box (FIG. 2). The numbers of ants feeding on the hydrogel beads were recorded at 5, 15, 30, 45, and 60 min. The experiment was replicated five times using five different colonies. Ant count data were normalized using log₁₀ (x+1) transformation. One-way ANOVA and Tukey's HSD test were used to compare the number of ants feeding on hydrogel matrices at each time period (SPSS Inc, 2002).

### Experiment 4: Characterization of Alginate Hydrogel Beads Conditioned in Liquid Baits Containing Thiamethoxam

Based on the result of experiment 1, 1% Na-Alg solution, 0.5% CaCl₂ solution, and 5 min crosslinking time were chosen to produce alginate hydrogel beads. After being removed from the crosslinker and rinsed with deionized water, the initial diameter of alginate hydrogel bead was measured using a Cen-tech digital caliper (Harbor Freight Tools, Camarillo, Calif., USA). The weight of bead was also measured with an analytical scale. The beads were then conditioned in 100 ml of 25% (wt:vol) sucrose solutions with varying concentrations of technical thiamethoxam [0, 0.00001%, 0.00004%, 0.00007% and 0.0001% (wt:vol)] for 24 h. All solutions were prepared with deionized water. As a negative control, hydrogel beads were conditioned in deionized water without sucrose and thiamethoxam. After the 24-h conditioning period, the beads were removed from the solutions and excess moisture on the surface was gently removed using a laboratory tissue. Diameters and weights of the fully swollen beads were measured. The experiment was replicated ten times. One-way ANOVA and Tukey's HSD test were used to compare the percent diameter increase and percent weight gain between the different treatments (SPSS Inc, 2002).

Surface morphology of the conditioned alginate hydrogel beads was examined using scanning electron microscope (SEM) (FEI Nova NanoSEM 450, FEI Corp., OR, USA). Acceleration voltage used was 10 kV. The hydrogel beads were vacuum-dried and coated with gold/palladium prior to SEM. Hitachi™-1000 tabletop SEM (Tokyo, Japan) was used to observe the hydrogel beads without vacuum drying and gold/palladium coating.

### Experiment 5: Amount of Thiamethoxam in the Hydrogel

To determine if thiamethoxam from the aqueous solution is absorbed into the hydrogel matrix, the amounts of thiamethoxam in the outer and inner portions of the hydrogel beads were estimated and compared using an enzyme-linked immunosorbent assay (ELISA). Details of the method were described in Rust et al. (2015). Alginate hydrogel beads were conditioned in 100 ml of 25% sucrose solution containing 0.0001% (wt:vol) of thiamethoxam. Control hydrogel beads were conditioned in a 25% sucrose solution. After a 24-h (24 hours) conditioning period, the hydrogel beads were removed from the solutions. The hydrogel bead was trimmed from the outside using a clean dissection knife leaving a small inner cube. The final amount of sample for each part of hydrogel bead (i.e., trimmed pieces from surface and a cube obtained from inside) weighed exactly 0.05 g. The samples were placed into separate 1.5-ml centrifuge tubes and 0.3 ml of distilled water was added to each tube. The hydrogel samples were homogenized with a plastic pestle and centrifuged (Thermo Scientific IEC Medilite microcentrifuge, Waltham, Mass., USA) for 5 min. Then, 4 μl of supernatant was pipetted out and diluted in 996 μl of distilled water (250-fold dilution). The amounts of thiamethoxam in hydrogel samples were estimated using a commercially available ELISA kit (Thiamethoxam H.S. Plate Kit, catalog no. 20-0102, Beacon Analytical System Inc., Saco, Me.) with a procedure that is described in Byrne et al. (2005). The experiment was replicated four times. The estimated amounts of thiamethoxam were compared between outer and inner portions of the hydrogel bead using a paired t-test (SPSS Inc, 2002).

### Experiment 6: Laboratory Small Colony Test

Efficacies of the alginate hydrogel baits containing several different concentrations of thiamethoxam were tested with laboratory colonies of Argentine ant. Each experimental colony had 300 workers, two queens and 0.1 g of brood (mixtures of eggs, larvae and pupae) obtained from the main stock colony. The experimental colonies were kept in polyethylene containers (330 by 190 by 100 mm), with the inner side surfaces coated with a thin film of Teflon in order to prevent them from escaping. A petri dish (100 mm in diameter and 15 mm in height) with four small entry holes, containing folded corrugated paper (140 by 60 mm), served as the artificial nest site. The ants were provided with water, a 25% sucrose solution, fresh-killed cockroaches and canned tuna fish once a week. The colonies were acclimatized for seven days before conducting the experiment. All food items were removed from the colony boxes three days prior to baiting.

Efficacies of alginate hydrogel baits were tested with four different rates of thiamethoxam. The alginate hydrogel beads were conditioned in a 25% sucrose solution with 0.00001%, 0.00004%, 0.00007%, or 0.00010% (wt:vol) technical grade thiamethoxam (Sigma Aldrich, St. Louis, Mo.). Three freshly prepared hydrogel beads were placed on the bottom of the colony box. Control colonies were provided with alginate hydrogel beads conditioned in a 25% sucrose solution. At 24 h post-treatment, the experimental colonies were assigned back to their normal food items.

From photographs of the artificial nest sites taken from various angles, the number of live queens and workers were counted at 1, 3, 5, 7 and 14 days post-treatment. The weight of brood was also measured at these time points. The brood was typically found inside the artificial nest sites in the experimental colony. The experiment was replicated five times. Percent reductions in the number of workers and queens, and weight of brood were arcsine square-root transformed prior to analysis. Data were analyzed using one-way ANOVA. Mean values were then separated with Tukey's HSD test (SPSS Inc, 2002). (Tables 5 and 6).

### Experiment 7: Field Efficacy Test

Efficacy of the alginate hydrogel baits containing 0.0001% of thiamethoxam [the most efficacious concentration tested based on the laboratory study (see Results)] was tested at five residential houses in Riverside, Calif., USA from July 28 to Sep. 23, 2016. All sites had Argentine ant as the primary pest ant.

To increase the scale of production of alginate hydrogel baits for field experiments, droplets of 1% Na-Alg solution was produced using a 100-nozzle shower head (AKDY AZ-6021 8-inch bathroom chrome shower head, CA, USA). The Na-Alg solution was slowly poured into a large funnel (15 mm in diameter) connected with the showerhead, and the droplets of Na-Alg solution from the showerhead were collected in a plastic container (381×292×152 mm) with 0.5% CaCl₂ crosslinker solution. The funnel plus showerhead was held by a clamp on a retort stand. The crosslinker was continuously stirred with a glass rod throughout this process to prevent the formed beads from adhering to each other. The resulting alginate hydrogel beads prepared from 5 L of Na-Alg solution were filtered out and conditioned in 5 L of 50% sucrose solution with 0.0002% of thiamethoxam for 24 h. It was assumed that concentrations of thiamethoxam and sucrose solution inside and outside of the hydrogel beads reached equilibrium by end of the 24 h conditioning period, which produced alginate hydrogel baits containing ˜25% sucrose solution with ˜0.0001% of thiamethoxam. The hydrogel baits were sieved out from the liquid bait and stored in plastic jars in a fridge at 4±1° C. and 20±5% RH until used.

Each experimental site was treated with ˜1 kg of hydrogel baits in an application rate of 10 g m⁻². The hydrogel baits were applied in ˜20 piles, each pile consisting of ˜50 g of alginate hydrogel baits within 5 m from the building and on active ant trails. Estimation of foraging activity levels of Argentine ants before and after treatment were based on the amount of sucrose solution consumed by ants over a 24-h period. On each monitoring date, a total of 20 monitoring tubes (15 ml Falcon plastic tubes, BD bioscience, San Jose, Calif., USA), each containing 12 ml of 25% sucrose solution were placed at 10 different points evenly distributed along the perimeter of each house. A set of two tubes was placed at each point with the open end propped up in the notch of two Lincoln Logs™ and covered with a flower pot (155 mm in diameter and 115 mm in height) to protect the tubes from sprinkler irrigation, pets, precipitation, and sunlight. The amount of sucrose solution consumed by the ants was determined by measuring the difference between the initial and finial weights of the tubes over 24 h and then correcting for evaporation. The correction for evaporation was based on the weight loss from another set of monitoring tubes placed at another site in Riverside, Calif., USA for 24 h, which ants could not access. Based on previous studies, Argentine ants consume on average 0.3 mg of sucrose solution per visit. Based on this assumption, the number of ant visits to each tube was estimated, and the mean value between two tubes was used for further analyses. Field sites were monitored on day 1 pre-treatment, and weeks 1, 2, and 4 post-treatment. The second treatment with hydrogel baits was made immediately after the monitoring at week 4, and sites were further monitored at weeks 5, 6, and 8 post-treatment (calculated from the dates of first treatment deployment at the site). The amount of alginate hydrogel baits deployed per site and the method of application for the second application were identical to the first application.

Based on the visual inspection of the monitoring tubes upon pick up, only Argentine ants were found to be foraging in the monitoring tubes throughout the experimental period. The average numbers of ant visits recorded at each site for all monitoring dates were square-root transformed to satisfy normality assumptions. The number of ant visits at each post-treatment monitoring date was compared with the pre-treatment level with paired t-tests at the 0.05 level of significance.

### Results

### Experiment 1: Engineering Alginate Hydrogel with Optimal Properties

Analysis of univariate ANOVA revealed that the main effects of Na-Alg concentration (F=124.2; df=2, P<0.05), CaCl₂ concentration (F=1612.1; df=2, P<0.05) and crosslinking time (F=1058.6; df=2, P<0.05) on hydrogel percentage weight gain were statistically significant (Table 2). Furthermore, significant interactions were observed among those three factors (F=27.1; df=8, P<0.05) (Table 2). Multiple linear regression analysis of the hydrogel percentage weight gain with the effects of Na-Alg concentration, CaCl₂ concentration and crosslinking time gave correlation coefficient of r=0.141, r=−0.661, r=−0.529, respectively, revealed that all the effects were significant (P<0.05). The regression equation that modeled the linear relationship was Y=352.580−150.662 X₁−7.317 X₂+49.000 X₃ (R²=0.737, F=248.877, df=3, 266, P<0.05) where X₁=CaCl₂ concentration, X₂=crosslinking time, X₃=Na-Alg concentration and Y=hydrogel percentage weight gain, meaning that a one-unit increase in the CaCl₂ concentration and crosslinking time would decrease the hydrogel percentage weight gain by 150.662 and 7.317%, respectively. On the other hand, a one-unit increase of Na-Alg concentration would increase the hydrogel percentage weight gain by 49.000%. Hence, the formulation of 0.5% CaCl₂ solution with 5 min crosslinking time was chosen because it produced beads with highest percentage weight gain upon conditioning in sucrose solution. However, the formulation of 1% Na-Alg solution was chosen instead of 2%, because 1% Na-Alg solution produced firm spherically-shaped beads without disintegrate the hydrogel beads upon conditioning in sucrose solution.

### Experiment 2: Water Loss of Alginate Hydrogel Beads Under Simulated Moisture Conditions

Hydrogel matrices conditioned in 25% sucrose solution were exposed to six different combinations of moisture conditions (dry vs. wet sand substrate and 0, 32, and 75% RH in atmosphere) for 24 h. For the initial first 8 hours, hydrogel beads kept on wet sand substrate at 0% and 32% RH did not differ significantly among each other; no significant difference were also found between hydrogel matrices kept on dry sand substrate at 0% and 32% RH (2 h, F=44.85, df=5, 54, P<0.05; 4 h, F=71.12, df=5, 54, P<0.05; 6 h, F=102.58, df=5, 54, P<0.05; 8 h, F=97.00, df=5, 54, P<0.05) (FIG. 1). The hydrogel matrices kept on wet sand substrate at 75% RH had the lowest percentage of water loss compared with all other treatments throughout the experimental period (P<0.05) (FIG. 1).

### Experiment 3: Choice Feeding Study with Partially Dehydrated Hydrogel Matrices

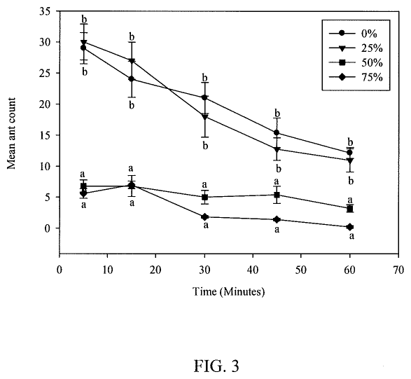

In general, all the hydrogel matrices were attractive to Argentine ant as the foraging workers started to feed on them immediately after the introduction of the hydrogel matrices to the colonies (FIG. 2). However, significant differences in the number of workers foraging on the hydrogel matrices were found between hydrogel matrices that lost 0% and 25% of water and hydrogel matrices that lost 50% and 75% of water at all time period throughout the experimental period (P<0.05) (FIG. 3).

### Experiment 4: Characterization of Alginate Hydrogel Beads Conditioned in Liquid Baits Containing Thiamethoxam

The resulting Ca-Alg hydrogel beads formed spherical shapes of diameters ranging between 5.81±0.05 mm and 6.00±0.05 mm (Table 3). Following the conditioning period, however, the beads swelled markedly and the diameters increased to 8.84±0.06 mm to 10.00±0.06 mm (Table 3). Yet, none of the percentage increase in mean diameters of the beads conditioned in the sucrose solutions was statistically different (P<0.05). However, the percentage increases in those mean diameters was significantly larger for the beads conditioned in deionized water than for beads conditioned in the 25% sucrose solution (P<0.05) (Table 3).

After crosslinking, all hydrogel beads used in the present work had an initial weight of 0.14 g (Table 3). After conditioning, their final weights ranged between 0.48±0.00 g and 0.57±0.01 g (Table 3). Interestingly, similar to the percentage increase in mean diameters findings, significant differences in the percentage weight gain were recorded between the hydrogel beads conditioned in the sucrose solutions and deionized water (P<0.05). However, the hydrogel beads conditioned in these sucrose solutions had similar percentage weight gain regardless of the presence or absence of insecticides (P<0.05), further supporting the notion that thiamethoxam in the liquid bait did not influence the hydration of the hydrogel beads (Table 3).

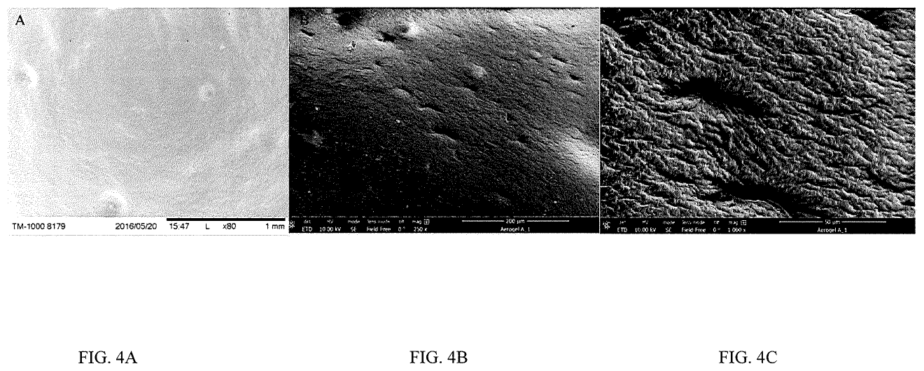

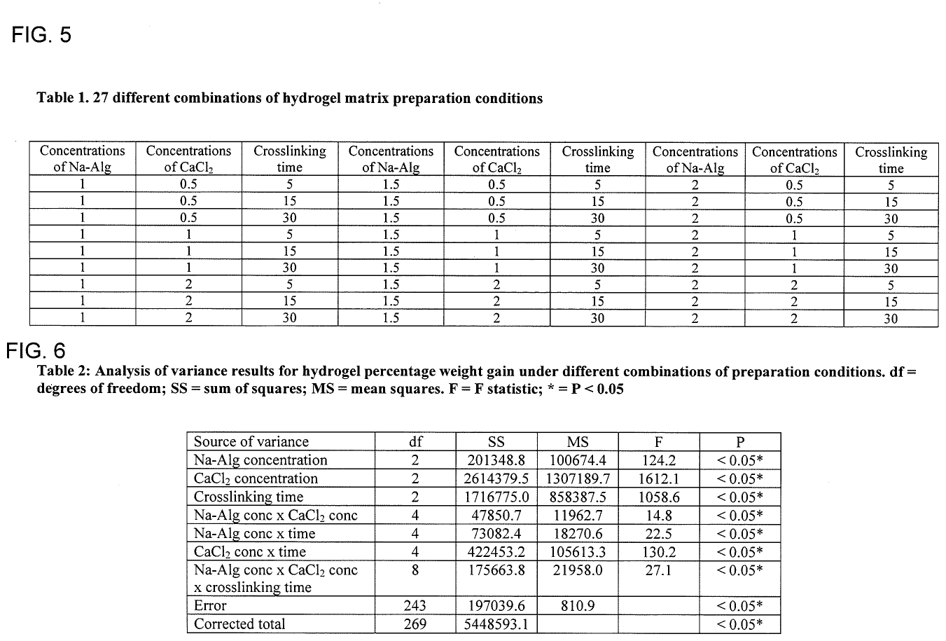

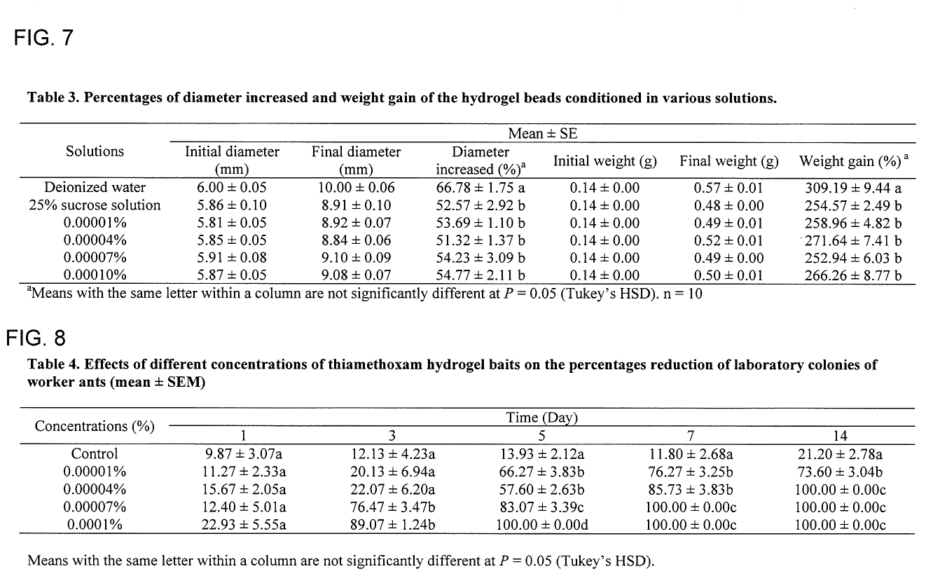

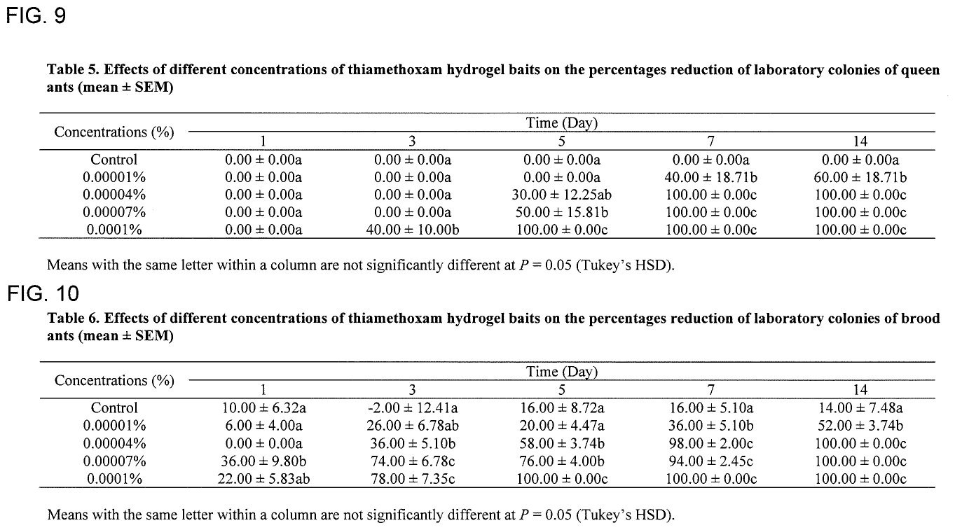

Scanning electron microscope revealed that wet hydrogel bead had an almost smooth gel surface structure without visible pores after a 24-h conditioning period (FIG. 4A); vacuum dried alginate hydrogel bead had a few small pores and some folds opened into elongated pores, with the estimated size of approximately 50 μm (FIGS. 4B and 4C).

### Experiment 5: Amount of Thiamethoxam in the Hydrogel

Thiamethoxam migrated uniformly throughout the alginate hydrogel matrix. The estimated amounts of thiamethoxam per gram of hydrogel were 1539.77±93.05 ng and 1214.28±50.69 ng (mean±SEM) for the surface and interior of the alginate hydrogel matrix, respectively. They were not significantly different (t=2.27, df=3, P=0.11). Although a low level of absorbance (25.46±2.99 and 12.29±0.62) were detected by the ELISA, the absorbance values are negligible and potentially caused by a minor matrix effect.

### Experiment 6: Laboratory Small Colony Test

Alginate hydrogel baits provided effective control of Argentine ant workers at tested concentrations of thiamethoxam (0.00001-0.0001%). No significant difference in the percentage of worker reduction was observed among all treated and untreated colonies at Day 1 (P<0.05). At Day 3, significant differences in the percentage of worker reduction was recorded for colonies treated with the two higher concentrations of thiamethoxam compared with that of control (P<0.05). Moreover, at Day 5, significant differences in the percentage of worker reduction recorded for all treated colonies, compared with those of control (P<0.05). Colonies treated with the hydrogel baits conditioned in 0.0001%, 0.00007%, and 0.00004% of thiamethoxam achieved a complete worker mortality by Day 5, 7 and 14, respectively (Table 4).

The hydrogel baits provided an effective control for queens and brood. Significant differences in the percentages of queen and brood reduction was recorded in colonies treated with the hydrogel baits conditioned in 0.0001% of thiamethoxam compared with that of control, starting at Day 3 (P<0.05). Additionally, at Day 7, significant differences in the percentages of queen and brood reduction was recorded for all treated colonies, compared with those of control (P<0.05). The hydrogel baits conditioned in 25% sucrose bait with 0.00004-0.0001% of thiamethoxam provided a 100% mortality rate for queens by Day 7, and for brood by Day 14 (Tables 5 and 6).

### Experiment 7: Field Efficacy Test

Average ant visits to monitoring tubes in all post-treatment monitoring dates were significantly lower than their respective pre-treatment estimates throughout the entire experimental period (week 1, t=3.6, df=4, P=0.023; week 2, t=3.6, df=4, P=0.022; week 4, t=4.4, df=4, P=0.012; week 5, t=5.7, df=4, P=0.005; week 6, t=3.7, df=4, P=0.020; week 8, t=6.9, df=4, P=0.002). For the first two weeks post-treatment, the hydrogel baiting provided widely variable control efficacies ranging from 7.8 to 65.1% reduction in ant visits. In average, 61-72% reductions in ant visits were recorded between week 4 and 6 post-treatment with one site showing 88% reduction at week 4. By week 8 post-treatment, ant visits were reduced by 64-91% when compared to the corresponding pre-treatment data. In average, this equated to an overall 79% reduction in ant visits.

### Discussion

Alginates are polysaccharides that are widely distributed in nature. They consist of (1-4)-linked β-D-mannuronic acid (M) and α-L-guluronic acid (G) monomers of varying proportions and sequences. Ca-Alg is created by the formation of a three-dimensional network structure between the cross-linking agent molecules, calcium ions, and the functional groups, the carboxyl groups extending from blocks of guluronic acid residues alongside the alginate polymer chain. In accordance with an exemplary embodiment, alginate hydrogel matrices made from seaweed can be used as liquid bait delivery systems in agricultural, natural and urban settings as they are biodegradable, non-toxic, cost effective and commercially available for large scale operations.

In this disclosure, the hydrogel matrix preparation conditions such as Na-Alg concentration, crosslinker concentration and crosslinking time significantly influenced the hydrogel percentage weight gain upon conditioning in a sucrose solution. The hydrogel percentage weight gain was calculated using hydrogel initial and final weights where the initial weights of hydrogel matrices were recorded after they are being removed from the crosslinking solution and rinsed with deionized water. It was observed that drying the hydrogel matrices (for example, by exposing them in the room temperature or vacuum oven for a few hours up to few days) prior to conditioning in a sucrose solution could affect their percentage weight gain (unpublished data). Hence, the hydrogel beads were conditioned in the sucrose solution immediately after being crosslinked and rinsed with deionized water; and the final weights of hydrogel beads were recorded after a 24-h conditioning period. Hydrogel percentage weight gain increased with the increase of Na-Alg concentration due to the increasing amount of polymer. However, some of those hydrogel beads produced with higher concentrations of Na-Alg (1.5% and 2%) were disintegrated upon conditioning in sucrose solution in this study. The hydrogel matrix produced from a polymer solution with higher concentrations would contain more polymers per unit amount of the hydrogel, potentially allowing it to absorb larger amount of water. As a result, the polymer network could not sustain the increase of volume and disintegrated into small fragments after 24-h conditioning period due to over-hydration. Hence, 1% Na-Alg was used to produce firm spherically-shaped beads. On the other hand, the hydrogel percentage weight gain decreased when the crosslinker concentration increased from 0.5% to 2% and when the crosslinking time increased from 5 minutes to 30 minutes. The increase of the crosslinker concentration (calcium ions concentration) and crosslinking time causes the increase of crosslink density of the bead, increase the rigidity hence decrease the hydrogel percentage weight gain. The increase of crosslink density reduces the mesh and pore sizes hence restrain the penetration and uptake of water molecules through the polymer network structure and subsequently affect the release of the incorporated compound from the hydrogel baits. Therefore, 0.5% crosslinker with 5 min crosslinking time were used in current study.

The current disclosure also provided useful insight on regression model based on 27 different combinations of preparation conditions, which could aid the fabrication of alginate hydrogel beads of different percentage weight gain for various applications, making them highly versatile. For example, Ca-Alg hydrogel matrix can also be easily formed by mixing/immersing specific concentrations of Na-Alg and CaCl₂ in a big container for large scale baiting program. Alternative gel-forming hydrocolloids, like gelatin, has been explored for encapsulation and delivery of sugar liquid bait targeting Argentine ants. Gelatin forms thermo-reversible two-component gels (for example, gelatin and water). On the other hand, alginate hydrogels are three-component systems (for example, alginate, water and salts) in which the third component could be added in a controlled manner to produce beads of a magnitude of desirable weight or size that may affect the release of the incorporated compound from the hydrogels. Furthermore, gelatin has a low melting temperature of 35° C. As opposed to gelatin, alginate hydrogels are thermo-irreversible, for example, heat-stable. Hence, alginate has the advantage over gelatin, as well as the potential to be used in warm regions around the world including tropical regions. Yet, like gelatin, the alginate hydrogel is subject to degradation via physical, chemical, and biological processes when it is applied on the soil surface.

Previous studies sought to encapsulate agricultural pesticides by incorporating pesticides, such as carbaryl and chlorpyrifos during the bead synthesis by adding the pesticides in the Na-Alg solution. In contrast, the beads in the current study were formed before loading them with bait solution by conditioning in a sucrose-based liquid bait of a known concentration. Because most of the pest ants are naturally adapted for feeding on sugary liquids, there is little doubt in that sugar-based liquid ant baits would be among the ideal choices for pest ant management for urban, agricultural, and natural settings. In the current disclosure, the beads acted as carriers of liquid bait designed to be used for bait application against ants after complete swelling. Hence, our novel bait manufacturing method can be considered the first to offer a biodegradable insecticide-containing sucrose-based alginate hydrogel matrix to be used as a liquid bait delivery system for ants.

The present disclosure also provides useful data on the percentage of water loss from alginate hydrogel matrix relevant to different atmospheric and substrate moisture conditions, as the water loss was found to be dependent upon these parameters in the environment. Wet sand was used to simulate wet soil surfaces upon irrigation as commercial orchards receive regular irrigation (personal communication). The water loss dynamics of hydrogel matrices in atmospheric moisture of 0% and 32% RH in both wet/dry sand shows that substrate moisture are more influential compared with the atmospheric moisture level at the first 8 h, unless the atmospheric moisture is 75% RH (FIG. 1). Hence, it is critical to slow down the water loss from the hydrogel baits via evaporation by increasing the moisture level of the substrate (i.e., soil), subsequently increase the window period during which the hydrogel baits maintain its attractiveness towards ants. It can be done by applying the hydrogel baits on the wet soil in the field. Hence, future studies could be carried out in the field with controlled irrigation.

It can be inferred from the findings in the water loss study that alginate hydrogel matrices are capable of absorbing moisture from the substrate (for example, sand), and maintain their attractiveness and palatability and remain effective longer as bait for ants. Next, we sought to determine exactly how long alginate bait remained attractive for ants as the hydrogel matrices lost its water content, by giving them a choice of hydrogel matrices with different amount of water loss. Results show that the hydrogel matrices lost their attractiveness to Argentine ants when 50% of the water was lost through desiccation (FIG. 3), showing some similarity to the findings of Rust et al. (2015). It was observed that hydrogel matrices gradually lose moisture over time but remain attractive for several hours upon introduction of the hydrogel matrices to the ant colonies. The initial discovery and consumption of the bait by foraging ants could be enhanced before the hydrogels lose too much moisture. Argentine ant pheromone could be incorporated in the alginate hydrogel baits to reduce initial bait discovery time.

From the observations of the hydrogel bead surface morphology, no pores were found on the wet hydrogel bead (FIG. 4A). However, it is suggested that wet hydrogel bead has pores, which absorb the water uptake in the hydrogel matrix similar with those pores observed on vacuum-dried hydrogel bead (FIGS. 4B and 4C). However, they are not visible under low magnification (80×) SEM because high magnification on SEM may expose fresh, wet hydrogel bead under longer period of vacuum that may damage/alter the surface of hydrogel bead (personal observation).

Thiamethoxam is a neonicotinoid insecticide that acts on an insect's central nervous system as a nicotinic acetylcholine receptors agonist. It is target site selective, having high efficacy against pest insects, while being safe on mammals, invertebrates and fishes. Note that it is not an irritant to the skin or the eyes. In accordance with an exemplary embodiment, thiamethoxam was tested as a candidate insecticidal compound for hydrogel bait development due to its relatively high water solubility of 4.1 g/L at 25° C., to be prepared in sucrose solutions, among the most important properties in formulating insecticide in aqueous sucrose solutions. Note that it can be crucial to achieve a complete replacement of the aqueous solutions between the water already contained inside the hydrogel matrix and the surrounding sucrose-based liquid bait during the 24-h conditioning period. In the current study, an ELISA test revealed that the liquid bait and the active ingredient of insecticide had the ability to diffused through the entire hydrogel matrix uniformly, suggest that thiamethoxam will be continuously accessible as the ants drink it from the hydrogel surface. Furthermore, the amount of thiamethoxam in the hydrogel matrix obtained from the ELISA test were almost similar with that of 0.0001% thiamethoxam liquid bait used to condition the hydrogel matrix, suggesting that the liquid in freshly made hydrogel beads was effectively replaced by sucrose-thiamethoxam solution through diffusion and equilibrium was probably achieved during the 24 hours conditioning period.

Previous studies indicate that 0.001% liquid thiamethoxam successfully reduced Argentine ants in urban settings. It was reported that polyacrylamide hydrogel conditioned with 0.0007% thiamethoxam liquid bait provided effective Argentine ant control in both laboratory study and field study at commercialized plum orchards. Boser et al. (2014) and Rust et al. (2015) successfully reduced the invasive Argentine ant population in a natural environment using 0.0006% thiamethoxam in polyacrylamide hydrogels. Bait that provided an LT₅₀ of foraging workers within 1 to 4 days was considered to possess delayed toxic effects in allowing sufficient time for the bait to be delivered throughout the colony. Fast-acting toxicants reduce trail establishment and maintenance, as the workers may die quickly. Rust et al. (2004) reported that liquid baits with thiamethoxam at wide ranges of concentration (0.00001-0.005%) provided complete mortality of laboratory colonies of queens and workers in a 14-day period. The current study indicates that even lower concentrations of thiamethoxam (0.00010-0.00001%) can kill the queen ant, although it has been diluted via trophollaxis. It is because thiamethoxam has a wide (10 to 1000-fold) concentration range for delayed toxicity. Furthermore, alginate hydrogel baits conditioned in all concentrations of thiamethoxam are not repellent; the ant trails were formed within minutes after the introduction of the alginate hydrogel baits. However, 21.20±2.78% of worker mortality was recorded in control colonies at Day 14. The percentage of mortality that we recorded in control is lesser than that of Rust et al. (2015) who recorded 32.6% of worker mortality in control at Day 8. In addition, Choe and Rust (2008) recorded 8-10% ant mortality at Day 7, which is comparable with our Day 14 results in this study.

Technical grade thiamethoxam was chosen in this study instead of Optigard ant gel bait as it has been associated with higher hydrogel percentage weight gain and lower cost. Extremely low concentrations of technical grade thiamethoxam were needed to reduce the ant population in the current study. By using hydrogel matrix as a delivery system, it was possible to achieve an effective control of field populations of Argentine ant with at least a hundred fold less amount of thiamethoxam compared to that would had been needed for conventional application of thiamethoxam. In addition, the use of alginate hydrogel matrix to deliver the liquid bait would reduce undesirable environmental impacts by eliminating accumulation of synthetic hydrogel compounds while allowing the effective ant management possible with minimal amounts of insecticide used. Despite being comparable with polyacrylamide hydrogels in terms of several properties, it does not leave any potentially toxic monomers in the environment. Future studies aimed to determine the water loss rate and the efficacy of alginate hydrogel baits as an alternative delivery system for liquid bait targeting populations of Argentine ant under field conditions are undergoing. Future tests can be conducted to explore the effectiveness of alginate hydrogel matrix in storing and delivering liquid baits containing other active ingredients besides thiamethoxam. The use of alginate hydrogel matrix to store and deliver the liquid bait can potentially change the way the liquid baits are used for the management of pest ants in natural, agricultural and urban settings.

The invention is not limited, however, to the embodiments and variations described above and illustrated in the drawing figures. Various changes, modifications and equivalents could be effected by one skilled in the art without departing from the spirit and scope of the invention as defined in the appended claims. It is expressly intended that all such changes, modifications and equivalents which fall within the scope of the claims are embraced by the claims.

What is claimed is:

1. A biodegradable hydrogel for delivering aqueous bait to control pest ants, the biodegradable hydrogel comprising:
a natural polymer of alginate cross-linked with calcium ions.

2. The biodegradable hydrogel of claim 1, wherein the natural polymer of alginate is a polysaccharide extracted from seaweeds or algae.

3. The biodegradable hydrogel of claim 1, comprising:
an active ingredient encapsulated within the biodegradable hydrogel.

4. The biodegradable hydrogel of claim 3, wherein the active ingredient is thiamethoxam.

5. The biodegradable hydrogel of claim 1, wherein biodegradable hydrogel are formed as spherical beads.

6. The biodegradable hydrogel of claim 5, wherein the hydrogel beads are submerged in a sucrose solution with an active ingredient.

7. A method of forming a biodegradable hydrogel for delivering aqueous bait to control pest ants, the method comprising:
ionotropically cross-linking sodium alginate with calcium ions.

8. The method of claim 7, wherein the sodium alginate is a polysaccharide extracted from seaweeds or algae.

9. The method of claim 7, comprising:
encapsulating an active ingredient within the biodegradable hydrogel.

10. The method of claim 7, wherein the active ingredient is thiamethoxam.

11. The method of claim 7, comprising:
forming the biodegradable hydrogel as spherical beads.

12. The method of claim 7, comprising:
the sodium alginate (Na-Alg) having a concentration of 1% to 2%;
the calcium ions are calcium chloride (CaCl₂) having a concentration of 0.5% to 2%; and
crosslinking the sodium alginate and the calcium ions for between 5 minutes to 30 minutes in deionized water to form hydrogel beads.

13. The method of claim 12, comprising submerging the hydrogel beads in a sucrose solution with an active ingredient.

14. The method of claim 13, wherein the active ingredient is thiamethoxam.

15. The method of claim 7, further comprising:
incorporating phagostimulant (sucrose solution) and insecticidal active ingredients (for example, thiamethoxam, boric acid, insect growth regulators) in a final bait products without any dilution.

16. The method of claim 7, further comprising:
preparing the alginate hydrogel beads first and subsequently conditioned them in the 25% sucrose with a known amount of toxicant (for example, thiamethoxam, boric acid, insect growth regulators).

17. The method of claim 7, further comprising:
using hydrogel beads containing sucrose solution as a baiting system targeting pest ants.

18. The method of claim 7, further comprising:
incorporating a species-specific pheromone (for example, Argentine ant trail pheromone, (Z)-9-hexadecenal) in a final bait product.

19. The method of claim 7, further comprising:
dispensing and collecting droplets of alginate solution using a shower head.

20. The method of claim 7, further comprising:
applying alginate hydrogels in urban residential houses.
